(19) United States
(12) Patent Application Publication
(10) Pub. No.: US 2011/0321062 A1
(43) Pub. Date: Dec. 29, 2011

(54) CAPTURING EVENTS FROM AND PROVIDING TARGETED MESSAGES TO A DIGITAL MEDIA DEVICE

(75) Inventors: Nick George Pope, Suwanee, GA (US); Theodore R. Grevers, JR., Milford, MA (US); Brian Davis, Medford, MA (US); Christopher Adam Maloney, Jamesburg, NJ (US)

(73) Assignee: CISCO TECHNOLOGY, INC., San Jose, CA (US)

(21) Appl. No.: 12/824,176

(22) Filed: Jun. 26, 2010

(51) Int. Cl. G06F 15/16; G06F 9/46; G06F 21/00

(52) U.S. Cl. 719/318; 709/206; 726/3

(57) ABSTRACT

Systems and methods for collecting events and providing messages using Extensible Messaging and Presence Protocol (XMPP), Session Initiation Protocol (SIP) or any other protocol that provides for authentication, presence and messaging. One such method is performed in a digital media device, such as a set top. A digital media device may collect events associated with usage and behavior and publish the information to a node. The node may communicate data to an aggregator and a harvester to reformat the data to make it available to analytics systems. In addition, the digital media device may subscribe to a node to receive notifications of messages having geographic or other relevance based on an identifier associated with the digital media device.

### BACKGROUND

Service providers of video/media may track what type, and how many users/subscribers are watching/using different media in the system. In general, this is called usage data. This usage data may be used to determine which video assets, games, applications, and other media are more popular, usually by demographic. Some systems may track which videos, games, applications, and other media an individual user prefers. In general, this is referred to as behavior data. Usage and behavior data are related in that they are both based on raw media events. Raw media events include information about which media asset, game, application etc. is being viewed/played/used, for how long, and whether the viewer skipped parts of the asset (e.g., fast-forward, rewind, etc.). Many entities specialize in the analysis of this raw data, providing trend analysis, collation, identity protection (for the user/subscriber), etc., however they perform the analysis using batched data collected from the users and/or media devices. Thus, the data is not received and/or analyzed real-time or near real-time.

For example, raw event data may be collected at a streaming point/video pump in the network. However, as systems continue to evolve towards offering broader media libraries from varying sources, including third party and Internet sources, much of the usage/behavior data for third party and Internet content can be missed by soley polling the service providers streamers/pumps. Therefore, a client-based collection may capture the full spectrum of events. However, the challenge with client-based collection is that it is often desirable to have a mixed ecosystem of data analysis tools (advanced advertising, trend analysis, audience measurement, recommendation engines, analytics, etc.). Thus, it is often not feasible to install a software module on each client for each analysis tool, as each software module collects roughly the same data, then reformats the data in its own unique format to be sent to its corresponding server. This is a waste of valuable resources in the client and wastes bandwidth in the service provider's network. Further, as disparate client modules are added to the client, it becomes harder to collect data in real-time, since many media clients (set tops, mobile phones, media players,) have limited software and hardware resources.

In addition to the above, there are FCC mandates that managed video systems in the United States comply to the Emergency Alert Service (EAS), which is used to notify subscribers of impending dangers. Traditionally, the infrastructure to support this was only available to users who were on the managed network and using managed network devices. With a mix of media devices both on and off the managed network accessing the managed service, it is difficult to provide notifications to subscribers in the mixed ecosystem.

### SUMMARY

Systems, devices, and methods for collecting events and providing messages using Extensible Messaging and Presence Protocol (XMPP), Session Initiation Protocol (SIP) or any other protocol that provides for authentication, presence and messaging. One such method is performed in a digital media device, such as a set top box.

In accordance with some implementations, there is provided a method for providing targeted messages to a device in a managed or unmanaged network. The method may include provisioning the device with an attribute, subscribing to a node identified by the attribute, receiving a notification from the node, and receiving a message from the node. The message may have a relationship to the attribute.

In accordance with some implementations, a method may be provided for collecting usage and behavior statistics at a media device. The method may include executing a collection function on the media device to capture events occurring on the media device, publishing the events to a Personal Event Protocol (PEP) node, aggregating the events from the PEP node at an aggregator, reformatting the events from the aggregator at a harvester to generate reformatted event data, and providing the reformatted event data to external analytics systems.

This summary is provided to introduce a selection of concepts in a simplified form that are further described below in the detailed description. This summary is not intended to identify key features or essential features of the claimed.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a block diagram of an environment in which implementations of the present disclosure may be provided.

FIG. 2 is a block diagram depicting a non-limiting example of the digital media device.

FIG. 3 is a diagram illustrating aspects of message flows between a client and a server.

FIG. 4 illustrates example message flows that may be used to provide services, such as localized message delivery or to publish usage and behavior information.

FIG. 5 is an exemplary operation flow diagram of processes performed to provide targeted message delivery.

FIG. 6 is another exemplary operation flow diagram of processes performed to provide targeted message delivery.

FIG. 7 is an exemplary operation flow diagram of processes performed to collect usage and behavior information.

FIG. 8 is another exemplary operation flow diagram of processes performed to collect usage and behavior information.

### DETAILED DESCRIPTION

Implementations are disclosed herein that provide systems, devices, and methods for collecting events and providing messages using Extensible Messaging and Presence Protocol (XMPP), Session Initiation Protocol (SIP) or any other protocol that provides for authentication, presence and messaging. One such method is performed in a digital media device, such as a set top box.

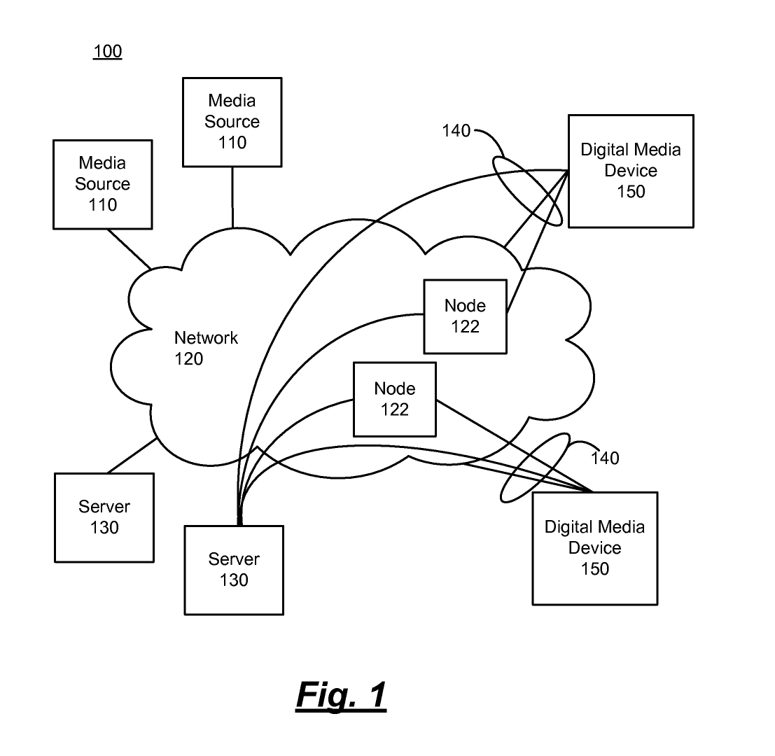

FIG. 1 is a block diagram of an environment in which implementations of the present disclosure may be provided. The system 100 may deliver various digital television, data, voice and video services to subscribers, which may include television programming, video-on-demand, pay-per-view, music, Internet access, applications, shopping, and telephone. The television services may be provided from various sources, such as a media source 110, which provides or transmits encoded media content in, for instance, a cable television network, a television services network, or originally from a broadcast television station. Other sources of media content or television services should be familiar to a person of ordinary skill in the art, and are intended to be within the scope of this disclosure.

Various media content sources may be located at a facility known as a “headend” which is operated by a television services provider (e.g., a network operator) that also may operate a network 120. The media source 110 may be part of the network 120. However, these components are not limited to residing at that location. The media content or video programs of television services, from various sources, are provided over network 120 to a digital media device(s) 150, which may include set top boxes, media center devices, personal computers (e.g., WINDOWS, MAC and/or Linux) mobile connected devices, etc.

In general, a content provider (not shown) provides content to one or more headends, which in turn communicate one or more hubs, nodes and taps in the network 120. In one example, fiber optic cable may be used to transmit optical signals from the hubs to the nodes. The optical signal may be converted to an RF signal at the node and transmitted to the tap and ultimately to the digital media device 150 by coaxial cable.

In some implementations, the network 120 may be an ATM or Ethernet network that includes an access node. The access node may connect to a residential gateway at a subscriber's premises. The residential gateway may be managed or unmanaged. One or more digital media receiver(s) 150 within the premises may be connected to the residential gateway via an IP connection to provide digital television, data and voice services. The network 120 may be an IP network that handles all types of traffic (video, data, voice, etc.). Quality of service (QoS) tools can prioritize the video traffic to prevent delay or fragmentation of the signal.

Common encoding and/or container formats for the content transported in the network 120 may include MPEG-2 video, H.264, MP4, or SMPTE VC-1, but others are contemplated to be within the scope of this disclosure.

In some implementations, network content (e.g., the Internet) may be provided to the digital media device 150. The content may be accessed at a server identified by a Uniform Resource Locator (URL) or Internet Protocol (IP) address, and downloaded from a network location to the digital media device 150. The content may be any type of data, including, but not limited to, multimedia content, audio, applications, interactive content, Web content, etc. The content may be made available by a service provider of the network 120 or from other sources.

The digital media device 150 receives, via the subscriber connection 140, the subset of video programs and services to which the subscriber subscribes. The digital media device 150 may select one or more of the delivered television services for presentation to a user (e.g., by “tuning” to a program). In some implementations, the digital media device 150 processes the one or more multiplexed media streams corresponding to the video program of the selected television service and converts them into a presentable or output form, such as a video signal, either in analog form or digital form. Processing may comprise decompression and reconstruction of the pictures in a received video stream. This video signal is supplied to a display (e.g., a television or computer monitor) for viewing by a subscriber. In some implementations, the digital media device 150 stores the video program of the selected television service for later presentation (e.g., digital video recorder or DVR).

In some implementations, the digital media device 150 may access and receive network content from, e.g., the Internet or other network location. As noted above, the network content may be any type of data. The data may be downloaded by a subscriber using the digital media device 150, or may be provided to the digital media device 150 by a service provider.

In some implementations, the digital media device 150 publishes certain items of information to a “publish-subscribe” (PubSub) node or Personal Event Protocol (PEP) node 122 via the subscriber connection 140. The node 122 may be an entity defined by XEP-0271: XMPP Nodes (published by the XMPP Standards Foundation), which identifies a particular facet or aspect of an XMPP domain, localpart, or resource. The node 122 may implement aspects of a “publish-subscribe” (PubSub) model where a person or application publishes information, and an event notification (with or without payload) is broadcasted to all authorized subscribers.

In general, the relationship between the publisher and subscriber may be mediated by a service that receives publication requests, broadcasts event notifications to subscribers, and enables privileged entities to manage lists of people or applications that are authorized to publish or subscribe. The focal point for publication and subscription is a “node” (i.e., node 122) to which publishers send data and from which subscribers receive notifications. Nodes can also maintain a history of events and provide other services.

The nodes 122 may be organized in a hierarchical (tree structure) and be one of two types. Leaf nodes are nodes that contain published items. Collection nodes are nodes that contain other nodes. Thus, when a user subscribes to the node 122, that node may be a leaf node where notifications are sent when new items are published to the node. Otherwise, the node 122 is a collection node, and notifications are made on addition/removal of child nodes or when new items are published to child nodes.

In other implementations, the digital media device 150 may subscribe to publications from the node 122. In such implementations, when information is published by the node 122, the digital media device 150 may receive notifications of new/update information via the subscriber connection 140.

A server 130 may provide messaging, presence, XML routing features, content, applications, data, etc. In some implementations, the server 130 may provide multimedia to the digital media device 150 for viewing by a subscriber. For example, the server 130 may be operated by a service that provides on-demand access to multimedia content. In some implementations, the server 130 may be located on the managed or unmanaged network and may be a Web server, FTP server, etc., that serves content, applications, data, etc. to the digital media device 150.

In some implementations, the server 130 may be a subscriber or publisher in a PubSub service. In other implementations, the server 130 may be a diagnostic component that initiates a command session with, e.g., the digital media device 150 to perform maintenance. In yet other implementations, the server 130 may be a storage component that stores private and/or public information, such as a configuration of the digital media device 150. In some implementations, the server 130 may use XMPP, SIP, or any other protocol that provides for authentication, presence and messaging.

In some implementations, the server 130 may be an aggregator or a harvester. The aggregator may be a device that receives raw media events from a PEP node 122 that subscribes to a digital media device 150. The aggregator may store and send the raw events to the harvester, or send the raw media events to the harvester as they are received from the digital media device(s) 150. The harvester may also pull the raw media events from the aggregator. The harvester reformats the raw media events to remove some data; or other data might be changed to protect the identity of the service provider's subscribers. In some implementations, the harvester may change the data from one XML format to another XML format. The harvester may then send the reformatted data to one or more analysis systems, or alternatively, the analysis systems may pull in the information from the harvester. The relationships of harvesters to aggregators to PEP nodes may be changed to scale up or scale down the numbers of servers 130 needed to collect the raw media events in a service providers' system. Thus, aggregators and harvesters may be added and subtracted, as needed. Further, the connectivities between the aggregators and harvesters may also be altered, as needed.

While the subscriber connection 140 is shown as plural connections to the network 120, the node 122 and the server 130, it is noted that the subscriber connection 140 may be one physical connection, such as a coaxial cable, Ethernet, fiber optic, or other physical media.

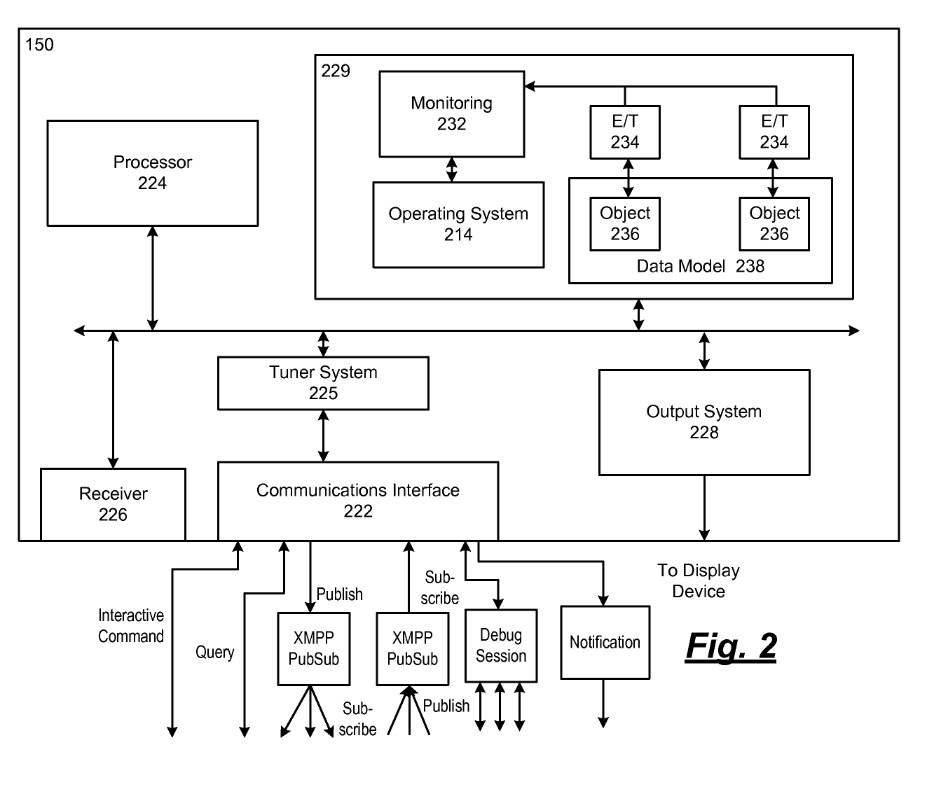

FIG. 2 is a block diagram depicting a non-limiting example of the digital media device 150. The digital media device 150 described herein is merely illustrative and should not be construed as implying any limitations upon the scope of the present invention. The digital media device 150 preferably includes a communications interface 222 for receiving signals (video, audio and/or data) from the headend within the network 120.

The digital media device 150 further includes at least one processor 224 for controlling operations of the digital media device 150, an output system 228 for driving a display device, and a tuner system 225 for tuning to a particular television channel to be displayed and for sending and receiving various types of data or media to/from the headend. The tuner system 225 includes, in one implementation, an out-of-band tuner for bi-directional Quadrature phase shift keying (QPSK) data communication and a Quadrature amplitude modulation (QAM) tuner for receiving television signals. Additionally, a receiver 226 receives externally-generated user inputs or commands from an input device such as, for example, a remote control device.

The processor 224 may provide for functions such as decoding, transcoding/encoding (converting from one format to another) and transrating (scaling from a higher to a lower bit rate) of various media streams, as well as having the ability to accommodate system-level functions such as decryption, encryption, packetization and transport of media streams. Besides broadcast content, the digital media device 150 may support content received from a home network or the Internet.

The communications interface 222 of the digital media device 150 may also include one or more wireless or wired interfaces (not shown), also called ports, for receiving and/or transmitting data to other devices. For instance, the digital media device 150 may feature a USB (Universal Serial Bus), an Ethernet port (for connection to a computer or network), an IEEE-1394 connection (for connecting to consumer electronics equipment), eSATA port (external Serial Advanced Technology Attachment for attachment of mass storage devices), and a serial port. Wireless interfaces include, but are not limited to, 802.11 (WiFi) 806.16 (WiMax), Bluetooth, Zigee, cellular, etc. User inputs may, for example, be provided via a computer, via buttons or keys located on the exterior of the digital media device 150, via a hand-held remote control device, and/or via a keyboard that includes user-actuated buttons, etc.

In one implementation, a system memory 229 may be provided within which various applications, modules and data may be stored for execution and use by the processor 224. Basic functionality of the digital media device 150 is provided by an operating system 214 that coordinates the resources of the digital media device 150 such as, for example, computing resources. One or more applications, may be executed by utilizing the computing resources in the digital media device 150. Applications stored in the system memory 229 are executed by processor 224 (e.g., a central processing unit or digital signal processor) under the auspices of the operating system 214.

Data required as input by an application is stored in the system memory 229, and read by processor 224 as need be during the course of the application's execution. Input data may be data stored in system memory 229 by a secondary application or other source, either internal or external to the digital media device 150, or possibly anticipated by the application and thus created with the application at the time it was generated as a software application. Data generated by an application is stored in system memory 229 by the processor 224 during the course of the application's execution.

In some implementations, the digital media device 150 may implement a monitoring agent 232 that interfaces with the operating system 214 and monitors one or more event/triggers 234. The monitoring agent 232 may monitor media events, diagnostic events, or other events within the digital media device 150. The event/triggers 234 respond to a defined set of expressions to set triggers on objects 236 within a data model 238. When a trigger is tripped, one or more events occur. Events may be actions, such as starting logging, generating notifications, performing a core dump, etc. Notifications may be small messages that are communicated over the network 120 to various recipients by the monitoring agent 232.

In accordance with some implementations, the communications interface 222 may be configured to provide for communications using various extensions of XMPP. XMPP is an XML-based protocol that provides messaging and presence information. XMPP operates behind a router and passes through network access translation (NAT) gateway devices. Thus, if the client is behind a NAT and/or Firewall gateway, in e.g., in a home, XMPP can be used to traverse the router to enable communications between the client and server. The extensions may be implemented to provide various capabilities to the digital media device 150. For example, the digital media device 150 may subscribe to events (e.g., geographically relevant events) or publish information about the digital media device 150 for collection (e.g., usage and behavior information). The digital media device 150 may be remotely commanded, queried or debugged by, e.g., the server 130 to perform diagnostic operations, report health and status, and to track state information. The digital media device 150 may report state information to the server 130. The digital media device 150 may also save information to the XMPP core network or and/or synchronize with another digital media device 150. Other features may be implemented in accordance with the XMPP extensions.

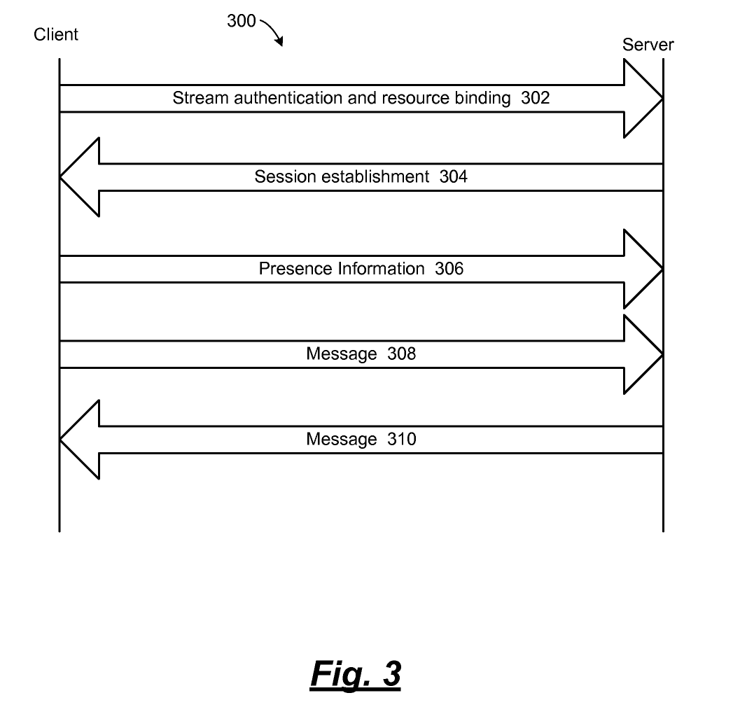

FIG. 3 is a diagram illustrating aspects of message flows 300 between a client (e.g., the digital media device 150) and a server (e.g., server 130). In some implementations the client and server communicate based on RFC 3920 (Extensible Messaging and Presence Protocol (XMPP): Core) and RFC 3921 (Extensible Messaging and Presence Protocol (XMPP):Instant Messaging and Presence). A client's session with a server may be viewed as XML streams and XML stanzas. The XML stream acts as an envelope for all the XML stanzas sent during a session. This may be represented as:

```
<stream>
  <presence>
  <show/>
  </presence>
  <message to=‘foo’>
  <body/>
  </message>
  <iq to=‘bar’>
  <query/>
  </iq>
  . . .
  </stream>
```

The attributes of the stream element are ‘to,’ which is used from initiating entity to the receiving entity. The ‘from’ attribute is used by the receiving entity to the initiating entity. the ‘id’ attribute is from the receiving entity to the initiating entity and is a unique identifier created by the receiving entity to function as a session key for the initiating entity's streams with the receiving entity. An ‘xml:lang’ attribute specifies the default language of any human-readable XML character data sent over that stream. The ‘version’ attribute is set to a value of at least “1.0” and signals support for the stream-related protocols.

In FIG. 3, a first message 302 from the client (e.g., digital media device 150) to the server (e.g., Server 130) may include a stream authentication to establish a session or send XML stanzas. XMPP includes a method for authenticating a stream by means of an XMPP-specific profile of the Simple Authentication and Security Layer (SASL) protocol. After completing stream authentication, a reply 304 from the server may be indicative of resource binding. A client binds a resource to the stream, such that the client's address may be of the form <user@domain/resource>, after which the entity is now said to be a “connected resource.”

After establishing a session, a client may send initial presence information 306 to the server in order to signal its availability for communications. The initial presence stanza includes the ‘to’ address to signal that it is meant to be broadcasted by the server on behalf of the client. After sending initial presence, an active resource is said to be an “available resource.” Upon receiving initial presence from a client, the server may send presence probes (i.e., presence stanzas whose ‘type’ attribute is set to a value of “probe”) of the user (client) to all contacts to which the user is subscribed in order to determine if they are available. The server may also broadcast initial presence of the user to all contacts that are subscribed to the user's presence information. After sending initial presence, the client may update its presence information for broadcasting at any time during its session. The client and server may then exchange messages 308, 310 regarding subscriptions, rosters, statuses, etc.

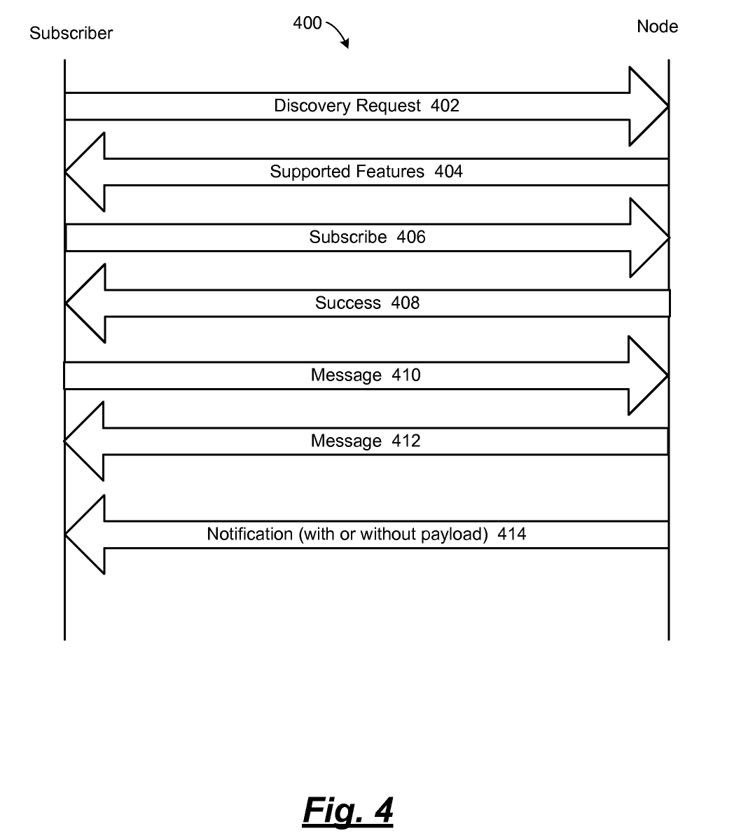

FIG. 4 illustrates example message flows 400 that may be used to provide services, such as localized message delivery or to publish usage and behavior information. A subscriber may send a discovery request 402 to a node 122. In response to the discovery request, the node 122 may respond 404 with the identity of its service and indicate which PubSub features are supported.

To subscribe to a node, a subscriber sends a subscription request 406 to the PubSub service node. In the subscription request, a <pubsub/> element contains a <subscribe/> element. The <subscribe/> element possess a ‘node’ attribute specifying the node to which the entity wishes to subscribe. The <subscribe/> element also includes a ‘jid’ attribute (an identifier) specifying the XMPP address to be used as the subscribed ID.

If the subscription request is successfully processed, the server informs the requesting entity that it is now subscribed with a success message 408. After the success message 408, other messages 410, 412 may be communicated between the subscriber and the node regarding configuration, requests for queued items at the node 122, error handling, etc.

Any entity that is allowed to publish items to the node 122 (i.e., a publisher or an owner) may do so at any time by sending an IQ-set to the service containing a pubsub element with a <publish/> child. The PubSub service then sends one <message/> stanza containing a PubSub event notification 414 to each entity that meets the criteria for receiving a notification (typically to each approved subscriber, although there are other contexts in which an entity may receive a notification). Each <message/> stanza generated by a PubSub service may possess an ‘id’ attribute with a unique value so that the service can properly track any notification-related errors that may occur. Depending on the node configuration, the event notification may or may not contain the payload.

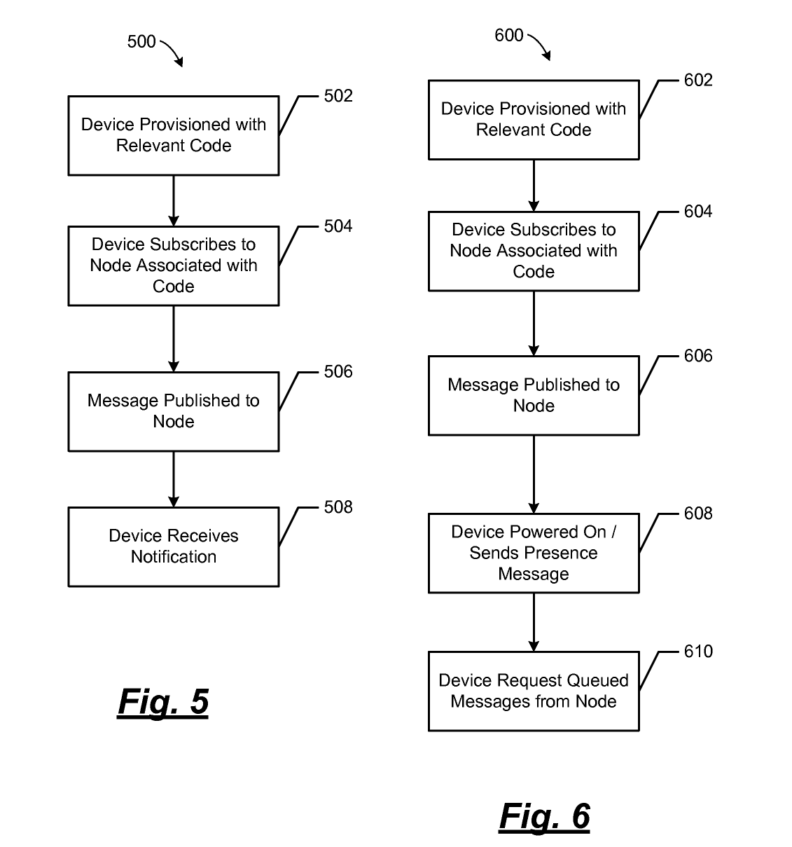

FIG. 5 is an exemplary operation flow diagram of processes 500 performed to provide targeted message delivery. At 502, a device is provisioned with a code. For example, the code may be a geographic (or other) identifier associated with an area in which the digital media device 150 is deployed. The code may identify a group of digital media devices for a specific purpose, such as providing localized emergency messages regarding weather or other catastrophes. In some implementations, the code may be related to services or programming to which a subscriber associated with the digital media device 150 subscribes. For example, the code may identify all subscribers to premium programming such that targeted advertising may be communicated to the subscribers not subscribing to the premium programming in order to entice the subscribers to sign up for the premium programming. As it is now evident, one of ordinary skill in the art would recognize that the code may be used to identify devices based on any specified criteria.

At 504, the device subscribes to a node associated with the code. For example, when the digital media device 150 signs on to the network 120, it may subscribe to the node 122, which may correspond to the provisioned code. At 506, a message is published to the node. The message may be published at any time, as necessary. A server on the network 120 may publish the message to the node 122.

At 508, the device receives a notification of the message. In some implementations, where XMPP protocol extension XEP-0060 is used, the subscribing digital media device 150 receives a notification together with the message published to the node 122. As noted above, the message may be information relevant to the code by which the device subscribes to the node 122. The digital media device 150 may then display the message to the subscriber's display device.

Alternatively or additionally, the example processes 500 may also be used to with a hierarchy of nodes 122 such that wider or narrower groups or areas of interested or affected devices may be notified of the messages.

In addition, the processes 500 may use geographic identifiers to control when a consumer can access content in the digital media device, such as applications or services. This allows a service provider to establish black-out restrictions on any aspect of what the consumer can do with their set top box.

FIG. 6 is another exemplary operation flow diagram 600 of processes performed to provide targeted message delivery. Processes 602-606 may be performed in substantially a similar manner as described with regard to 502-506. At 608, the device is powered on or sends a presence message. For example, the digital media device 150 may be powered on for the first time or may update its subscription with the node 122 based on a provisioned or a re-provisioned code sent to the digital media device 150 from the service provider.

At 610, the device may request queued messages from the node. For example, the digital media device 150 may send a message to the node 122 requesting the last (or other) message that was delivered to subscribers. In this manner, the device 150 may receive relevant messages even though it was not an active subscriber the time the message was published.

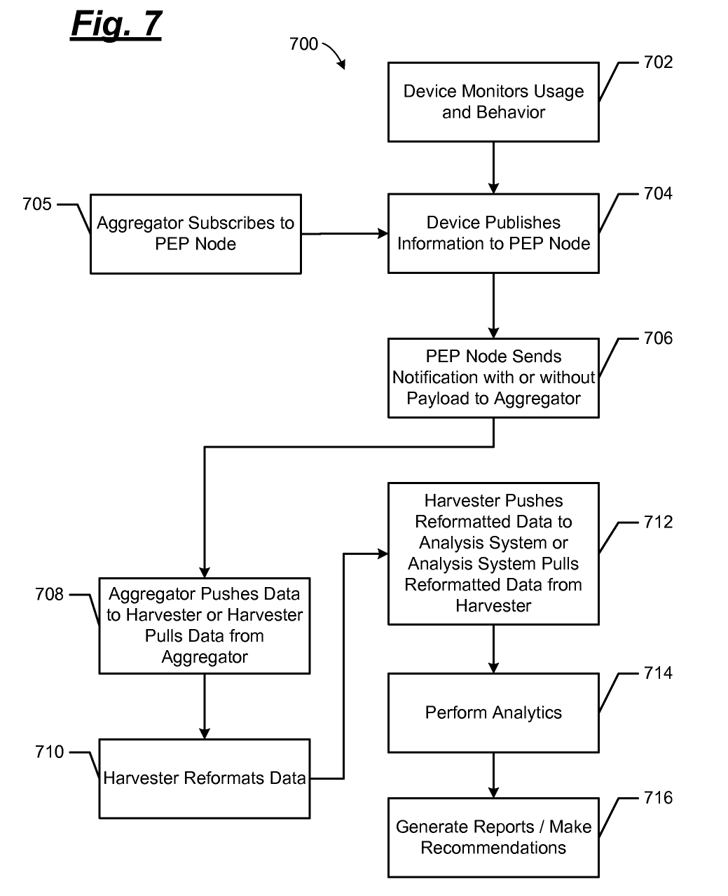

FIG. 7 is an exemplary operation flow diagram of processes 700 performed to collect usage and behavior information from a managed device. In accordance with some implementations, a service provider may track usage and behavior data from the digital media devices 150 in near real-time based on raw media events captured on the digital media device 150 using the processes 700.

At 702, a device begins to monitor its usage and behavior. For example, the digital media device 150 may include a collection function that captures events occurring on the device 150. For example, as a viewer watches a program on the digital media device 150, the collection function on the device may capture events that include, e.g., the programs recorded, if the subscriber fast forwarded or rewinded through portions of the program, if the subscriber paused the program, the time at which the subscriber began watching the program, etc.

At 704, the device publishes information to a PEP node. The PEP node may be a node defined in XEP-0163: Personal Eventing Protocol (published by the XMPP Standards Foundation). Personal eventing provides a mechanism for the, e.g., digital media device 150 user to send updates or “events.” As noted above, the events can be anything that a user wants to make known, or which the service provider has configured the device to make known. Thus, each digital media device 150 may be a publisher.

At 705, an aggregator subscribes to the PEP node(s). The aggregator may be indirectly feeding analysis systems which may be interested parties that perform analysis regarding advertising, viewer trends, audience measurements, recommendations, analytics, etc, as described below. The subscribing operation at 705 may occur concurrently or before the device monitoring at 702. Thus, there may be many subscribers and many publishers in view of the operations performed in 704 and 705.

At 706, the PEP node sends a notification (with or without payload) to the aggregator. As described above, the aggregator may be one or more of servers 130 that receive event data from a subset of digital media devices 150 in a population of devices. At 708, the aggregator pushes data to a harvester or the harvester pulls data from the aggregator. The harvester may be one or more of the servers 130, as described above. Using a push methodology, the aggregator may send event data to the harvester. Using the pull methodology, the harvester may retrieve data from the aggregator. Either may be used at 708 such that the harvester obtains the event data.

At 710, the harvester reformats the event data. The harvester may reformat the raw event data into one or more formats suitable to the different recipients. Some data may be removed; other data might be changed to protect the identity of the service provider's subscribers; and yet other data may be reformatted from XML format to another. The recipients may be an in-network recipient, managed by the service provider, or an off-network content provider such as NBC, CNN, ESPN, or anyone interested party.

At 712, the harvester pushes the reformatted data to an analysis system(s) or the analysis system(s) pull the reformatted data from the harvester. The analysis systems may be represented by one or more of the servers 130, as described above. Using a push methodology, the harvester may send event data to the analysis system(s). Using the pull methodology, the analysis system(s) may retrieve data from the harvester. Either may be used at 708 such that the analysis system(s) obtains the event data.

At 714, analytics may be performed on the raw or reformatted data by the analysis systems. At 716, reports or recommendations or other functions may be performed based on the analytics applied at 710.

Thus, in implementations using the processes 700, a statistics engine, analytics engine or recommendation engine may perform their functions with near real-time data to perform their functions in a more time-sensitive fashion. In accordance with some implementations, the numbers and relationships of aggregators and harvesters may be scaled up or down to accommodate the volume of event data and/or numbers of digital media devices 150. For example, an architecture may be designed with a one-to-may relationship of aggregators to digital media devices 150 and a one-to-many relationship of harvesters to aggregators. If demands become greater, a one-to-one relationship of aggregators to digital media devices 150 and a one-to-one relationship of harvesters to aggregators may be implemented.

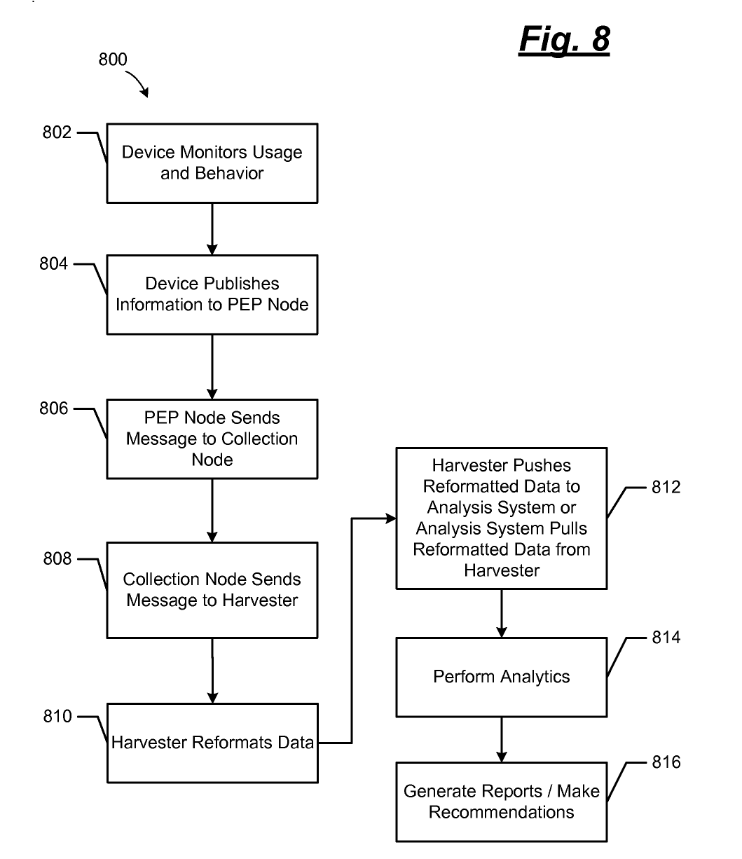

FIG. 8 is another exemplary operation flow diagram of processes 800 performed to collect usage and behavior information from a managed device. At 802, a device begins to monitor its usage and behavior. For example, the digital media device 150 may include a collection function that captures events occurring on the device 150. For example, as a viewer watches a program on the digital media device 150, the collection function on the device may capture events that include, e.g., the programs recorded, if the subscriber fast forwarded or rewinded through portions of the program, if the subscriber paused the program, the time at which the subscriber began watching the program, etc.

At 804, the device publishes information to a PEP node. The PEP node may be a node defined in XEP-0163: Personal Eventing Protocol (published by the XMPP Standards Foundation). Personal eventing provides a mechanism for the, e.g., digital media device 150 user to send updates or “events” to other users. As noted above, the events can be anything that a user wants to make known, or which the service provider has configured the device to make known. Thus, each digital media device 150 may be a publisher.

At 806, the PEP node sends a message to a collection node. The collection node may be a node defined by XEP-0248: PubSub Collection Nodes or XEP-0060: Publish-Subscribe. Each is published by the XMPP Standards Foundation. In general, the collection node is a type of node that contains nodes and/or other collections but no published items. Collections make it possible to represent more sophisticated relationships among nodes. The collection node acts as an aggregation point to the raw media data coming from client devices, e.g., video media device 150.

At 808, the collection node sends data to a harvester. The harvester may be one or more of the servers 130, as described above. At 810, the harvester reformats the event data. The harvester may reformat the raw event data into one or more formats suitable to the different recipients. Some data may be removed; other data might be changed to protect the identity of the service provider's subscribers; and other data may be reformatted from one XML format to another XML format. The recipients may be those identified above in 710.

At 812, the harvester pushes the reformatted data to an analysis system(s) or the analysis system(s) pull the reformatted data from the harvester. The analysis systems may be represented by one or more of the servers 130, as described above. Using a push methodology, the harvester may send event data to the analysis system(s). Using the pull methodology, the analysis system(s) may retrieve data from the harvester. Either may be used at 812 such that the analysis system(s) obtains the event data.

At 814, analytics may be performed on the raw or reformatted data by the analysis systems. At 816, reports or recommendations or other functions may be performed based on the analytics applied at 814.

Thus, in implementations using the processes 800, a statistics engine, analytics engine or recommendation engine may perform their functions with near real-time data to perform their functions in a more time-sensitive fashion. In accordance with some implementations, the numbers and relationships of collection nodes and harvesters may be scaled up or down to accommodate the volume of event data and/or numbers of digital media devices 150. For example, an architecture may be designed with a one-to-may relationship of collection nodes to digital media devices 150 and a one-to-many relationship of harvesters to collection nodes. If demands become greater, a one-to-one relationship of collection nodes to digital media devices 150 and a one-to-one relationship of harvesters to collection nodes may be implemented. In addition, the scaling up/down may also be implemented using an aggregator that receives messages from the collection node and then either pushes data to the harvester or has data pulled by the harvester.

In the implementations above, the functions of the server 130 and the digital media device 150 can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example but not limited to, a system or that is based on electronic, magnetic, optical, electromagnetic, infrared, or semiconductor technology.

Specific examples of a computer-readable medium using electronic technology would include (but are not limited to) the following: random access memory (RAM); read-only memory (ROM); and erasable programmable read-only memory (EPROM or Flash memory). A specific example using magnetic technology includes (but is not limited to) a portable computer diskette. Specific examples using optical technology include (but are not limited to) compact disk (CD) and digital video disk (DVD).

Any software components illustrated herein are abstractions chosen to illustrate how functionality is partitioned among components. Other divisions of functionality are also possible, and these other possibilities are intended to be within the scope of this disclosure. Furthermore, to the extent that software components are described in terms of specific data structures (e.g., arrays, lists, flags, pointers, collections, etc.), other data structures providing similar functionality can be used instead.

Any software components included herein are described in terms of code and data, rather than with reference to a particular hardware device executing that code. Furthermore, to the extent that system and methods are described in object-oriented terms, there is no requirement that the systems and methods be implemented in an object-oriented language. Rather, the systems and methods can be implemented in any programming language, and executed on any hardware platform.

Any software components referred to herein include executable code that is packaged, for example, as a standalone executable file, a library, a shared library, a loadable module, a driver, or an assembly, as well as interpreted code that is packaged, for example, as a class. In general, the components used by the systems and methods of reducing media stream delay are described herein in terms of code and data, rather than with reference to a particular hardware device executing that code. Furthermore, the systems and methods can be implemented in any programming language, and executed on any hardware platform.

The flow charts, messaging diagrams, state diagrams, and/or data flow diagrams herein provide examples of the operation of systems and methods. Blocks in these diagrams represent procedures, functions, modules, or portions of code which include one or more executable instructions for implementing logical functions or steps in the process. Alternate implementations are also included within the scope of the disclosure. In these alternate implementations, functions may be executed out of order from that shown or discussed, including substantially concurrently or in reverse order, depending on the functionality involved.

The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

What is claimed is:

1. A method for providing targeted messages to a digital media device, comprising:
provisioning the device with an attribute associated with a predetermined criteria;
subscribing to a node identified by the attribute;
receiving a notification from the node; and
receiving a message from the node, the message having a relationship to the attribute.

2. The method of claim 1, wherein the attribute is a geographic identifier.

3. The method of claim 2, further comprising:
provisioning the geographic identifier to digital media devices within a geographic region; and
communicating localized emergency messages to the digital media devices in accordance with the geographic identifier.

4. The method of claim 1, wherein the attribute is a service identifier, the method further comprising receiving targeted advertising from the node based on a value of the service identifier.

5. The method of claim 1, further comprising organizing the node into a hierarchy of nodes such that the hierarchy of nodes defines which of a plurality of digital media devices receives the notification and the message.

6. The method of claim 1, further comprising:
authenticating the device with the managed network; and
subscribing to the node upon authentication by the managed network.

7. The method of claim 1, further comprising:
requesting queued messages from the node; and
receiving the queued messages.

8. A method for collecting usage and behavior statistics at a media device, comprising:
executing a collection function on the media device to capture events occurring on the media device;
publishing the events to a Personal Event Protocol (PEP) node;
aggregating the events from the PEP node at an aggregator;
reformatting the events from the aggregator at a harvester to generate reformatted event data; and
providing the reformatted event data to external analytics systems.

9. The method of claim 8, wherein the events comprise first information about one of a media asset, game, and application, and wherein the events include second information regarding how the media asset is viewed, played or used.

10. The method of claim 9, wherein the events comprise raw events on the media device, the raw events being associated with usage and behavior characteristics.

11. The method of claim 8, further comprising removing information from the events to protect an identity of a subscriber of the media device when creating the reformatted event data.

12. The method of claim 8, wherein the events are either pushed from the aggregator to the harvester or pulled by the harvester from the aggregator.

13. The method of claim 8, wherein the reformatted event data is either pushed from the harvester to the external analytics systems or pulled by the external analytics systems from the harvester.

14. The method of claim 8, further comprising publishing the events to a personal eventing protocol (PEP) node and notifying the aggregator of the events in real-time.

15. The method of claim 14, further comprising communicating the events and the reformatted event data between the aggregator, the harvester and the external analytics systems in real-time.

16. The method of claim 8, further comprising:
performing analytics on the events; and
making recommendations to a subscriber of the media device proximate in time to when related events occurred on the media device.

17. The method of claim 8, further comprising defining relationships between the PEP node, the aggregator and the harvester in accordance with a volume of the events to be communicated, wherein the relationships provide for a scalability to accommodate the volume of events.

18. A method for performing behavior and usage analysis, comprising:
capturing events on a media device associated with programming provided to the media device;
publishing the events to a personal eventing protocol (PEP) node;
forwarding the events to a collection node substantially in real-time;
communicating the events to a harvester that reformats the events to create reformatted event data that removes personally identifiable information; and
analyzing the reformatted event data at an analytics system to provide a recommendation to a subscriber of the media device or to provide analysis with regard to programming viewed on the media device.

19. The method of claim 18, further comprising providing an aggregator that receives the events from the PEP node and communicates the events to the harvester.

20. The method of claim 18, further comprising providing a notification to the analytics system containing the reformatted event data.
